(19) United States
(12) Patent Application Publication
(10) Pub. No.: US 2007/0140609 A1
(43) Pub. Date: Jun. 21, 2007

(54) Slide bearing

(76) Inventors: Gerhard Gross, Lauf (DE); Martin Huber, Oberkirch (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/593,022

(22) PCT Filed: Feb. 3, 2005
(86) PCT No.: PCT/EP05/50466

§ 371 Date: Sep. 15, 2006

(30) Foreign Application Priority Data
Mar. 15, 2004 (DE) 10 2004 012 757.3

(51) Int. Cl. F16C 33/02

(52) U.S. Cl. 384/279

(57) ABSTRACT

A sintered slide bearing for a shaft of an electrical machine has a bore for the shaft and also has capillary gaps. It is saturated with a lubricant. The surface region of the bore has zones of different density, which are saturated with a low-viscosity poly-alpha-olefin lubricant. As a result, positive values are established for the long-term performance and cold noises in an arbitrary installed position.

### PRIOR ART

The invention is based on a slide bearing, in particular a sintered bearing, for a shaft, in particular of an electrical machine, which bearing has a bore for the shaft and also has capillary gaps and is saturated with a lubricant. Particularly if the electric motor is installed vertically, the risk arises, in conjunction with temperature superpositions and various operating states, that a large amount of lubricant will already be spun off in the first few hours in operation. This can also have an adverse effect on long-term performance.

### ADVANTAGES OF THE INVENTION

The slide bearing of the invention having the definitive characteristics of the independent claim has the advantage that the lubricant is better retained in the slide bearing, which has a favorable effect on long-term performance. So-called cold noise is also improved. To that end, a slide bearing of the invention, in particular a sintered bearing, for a shaft, in particular of an electrical machine, which bearing has a bore for the shaft and also has capillary gaps and is saturated with a lubricant, in which at least the surface region of the bore has zones of different density, which are saturated with a low-viscosity poly-alpha-olefin lubricant.

A lubricant whose viscosity at 40° C. is 22 mm²/s and at 100° C. is 4.8 mm²/s is especially suitable.

The ratio of the length to the width of the capillary gaps is preferably between 2.5/0.75 and 1.4/0.8. Better values are between 2/0.9 and 1.4/0.45.

An electrical machine having such bearings also has improved cold noises and lasts longer.

Further advantages and advantageous refinements will become apparent from the dependent claims and from the description.

### DRAWINGS

One exemplary embodiment is shown in the drawings and described in further detail in the ensuing description.

FIG. 1 shows an electrical machine, and

FIG. 2 shows a slide bearing.

### DESCRIPTION

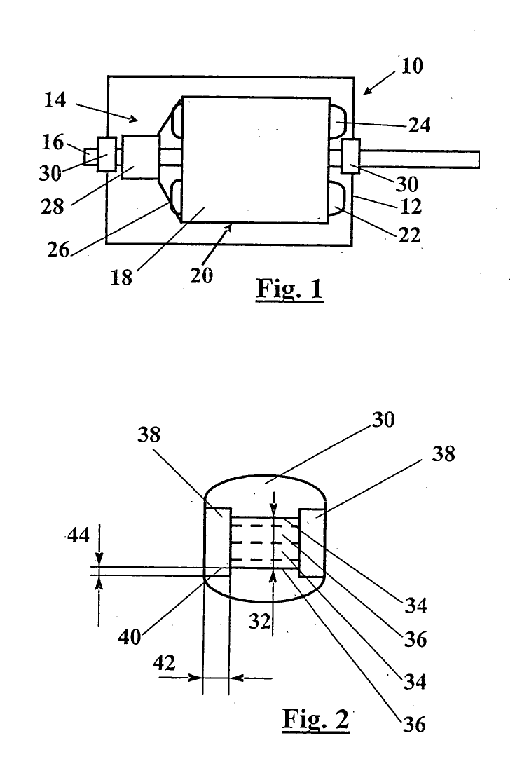

In FIG. 1, an electric motor 10 is shown, simplified, in a longitudinal section. The electric motor 10 may in a motor vehicle, for instance in a power window system, seat motor, or the like. The electric motor 10 includes a housing 12 and an armature 14 disposed in the housing. The armature 14 has a shaft 16 and an armature packet 18 with an armature winding 20, of which elements the protruding beads of two individual winding phases 22, 24 are shown. The winding phases 22, 24 are connected via wires 26 to a commutator 28. The shaft 16 is supported on the face ends of the electric motor 10 in two slide bearings 30.

In FIG. 2, one of the slide bearings 30 is shown in more detail. This is preferably a sintered bearing, which in the present exemplary embodiment is embodied as a cup bearing. The slide bearing 30 has a bore 32 for receiving the shaft 16. The bore 32 is slightly larger than the shaft 16. At least the bore 32, on its circumference in the surface region, has alternating zones 34, 36 of different density. The pores in the surface region are compacted variously strongly. This is due to the fact that during manufacture, the bore 32 initially has a diameter that extends between two radii. The zones 34 are located on a longer radius, and the zones 36 are located on a shorter radius. The bore 32 is then calibrated to its final size, or in other words widened. In that process, the pores of the zones 36 are compressed more strongly than those of the zones 34. As a result, the alternating zones 34, 36 of different density are created.

At least the zones 34, 36 are saturated with a poly-alpha-olefin lubricant, also written poly-α-olefin lubricant. This lubricant can be procured for instance from the Permawick Company, Birmingham, Mich., under the name P2AO110. It has a viscosity with the following values: At 40° C., it is 22 mm²/s, and at 100° C., it is 4.8 mm²/s. The viscosity index in accordance with DIN ISO 2909 is 130, and the so-called pour point in accordance with DIN ISO 3016 is −65° C. This medium has an evaporation loss after 10 hours at 150° C. of 9.6%; the gradient after 10 hours at 150° C. is 13.7%/min*10⁻³.

On each of its face ends, the bore 32 widens into a respective portion 38 of larger diameter. These two portions 38 each form an annular gap 40 with the inserted shaft 16. The annular gap 40 has a length 42 and a width 44 and can also taper toward the bore 32. The ratio of the length 42 to the width 44 is preferably between 2.5/0.75 and 1.4/0.8. The best results, however, ensue if the ratio of the length 42 to the width 44 is between 2/0.9 and 1.4/0.45.

Combining all the provisions results in favorable values in terms of the long-term performance and cold noises at an arbitrary installed position.

1-5. (canceled)

6. In a sintered slide bearing for a shaft of an electrical machine which bearing has a bore for the shaft and also has capillary gaps and is saturated with a lubricant, the improvement wherein at least the surface region of the bore has zones of different density, which are saturated with a low-viscosity poly-alpha-olefin lubricant.

7. The slide bearing as defined by claim 6, wherein the viscosity at 40° C. is 22 mm²/s and at 100° C. is 4.8 mm²/s.

8. The slide bearing as defined by claim 6, wherein the ratio of the length to the width of the capillary gaps is between 2.5/0.75 and 1.4/0.8.

9. The slide bearing as defined by claim 7, wherein the ratio of the length to the width of the capillary gaps is between 2.5/0.75 and 1.4/0.8.

10. The slide bearing as defined by claim 6, wherein the ratio of the length to the width of the capillary gaps is between 2/0.9 and 1.4/0.45.

11. The slide bearing as defined by claim 7, wherein the ratio of the length to the width of the capillary gaps is between 2/0.9 and 1.4/0.45.

12. An electrical machine having at least one bearing as defined by claim 6.

13. An electrical machine having at least one bearing as defined by claim 7.

14. An electrical machine having at least one bearing as defined by claim 8.

15. An electrical machine having at least one bearing as defined by claim 10.
